(19) United States
(12) Patent Application Publication
(10) Pub. No.: US 2026/0175611 A1
(43) Pub. Date: Jun. 25, 2026

(54) Method and Apparatus for Converting a Printed Paper Web into Book Blocks

(71) Applicant: Books Factory Spólka z Ograniczona Odpowiedzialnoscia, Szczecin (PL)

(72) Inventor: Daniel Krzanowski, Szczecin (PL)

(73) Assignee: Books Factory Spólka z Ograniczona Odpowiedzialnoscia, Szczecin (PL)

(21) Appl. No.: 19/428,016

(22) Filed: Dec. 19, 2025

(30) Foreign Application Priority Data
Dec. 21, 2024 (EP) 24222695

(51) Int. Cl. B42C 19/06; B42C 9/00; B65H 35/04

(52) U.S. Cl. CPC B42C 19/06; B42C 9/0081; B65H 35/04

(57) ABSTRACT

The invention relates to a method for converting a printed paper web into book blocks, in which a continuous printed paper web is processed having printed in the transverse direction rows of pages of at least two books. The paper web is cut into transverse strips containing rows of pages which are collected and aligned to form stacks of interconnected book blocks. The stacks forming interconnected book blocks are cross cut into individual book blocks. During the processing, the transverse strips are glued together by applying glue to the upper surfaces of the transverse strips near the axes associated with cutting of the transverse strips into individual book blocks such that the glue is applied after cutting the paper web into the transverse strips and before collecting the transverse strips into stacks.

### CROSS-REFERENCE TO RELATED APPLICATIONS

This application claim priority to European Application No. 24222695.9, filed on Dec. 21, 2024, the entire contents of which are incorporated herein by reference for all purposes.

### TECHNICAL FIELD

The object of the invention is a method and apparatus for converting a printed paper roll into book blocks. The solution is used in bookbinding work carried out on an industrial scale.

### BACKGROUND OF THE INVENTION AND STATE OF THE ART

In the state of the art, industrial bookbinding is known for its methods and equipment for processing the printed paper roll. A well-known method uses signatures, sections, in which a printed paper web is stretched and rewound on rollers and, during this operation, folded using ploughs. The paper web thus folded is then cut transversely. This produces signatures, in the case of books usually of six or eight pages which are grouped into book blocks. There are known inconveniences associated with the use of this method, in that there are blank pages at the end of the book. It is also a labour-intensive method and generates significant amounts of waste paper.

For example, EP2159070B2 discloses a method of manufacturing book blocks in which a printed paper web is converted into book blocks composed of signatures containing a sheet of paper folded at least in half. In this method, the printed paper web is printed on both sides, with the paper web being printed with individual sheets of the book forming the layout of the signature pages. The paper web thus printed is advantageously perforated lengthwise at the very beginning of the process to weaken the paper web at the perforation points. Then, at the cross-cutting station, the paper web is cut transversely with respect to the feed direction and the individual sheets are separated from the paper web. These sheets are folded at least once along the perforation line in a longitudinal folding station, where a signature is formed after the sheet is folded. The signatures are then moved to the stacking station, where the folded sheets are glued together in the folded edge area. The glue is therefore applied adjacent to that side edge which will be in the spine of the book block. The glue applied can either be in the form of a continuous path or it can be applied in spots. The glue is applied before or at the time when the signatures are arranged one on top of the other to form a stack forming a book block when the set of signatures is grouped. Glue is applied to the signatures forming the same book block. By such bonding, the folded sheets retain their position in the stack during transport and processing. Once the stack has been formed, the finished stacks are received by a feed station and directed either to an intermediate storage area or to a perfect binder where, during further processing of the book block, the applied glue is removed, in particular by milling carried out during processing of the book spine. According to this method, sheets of paper printed individually can also be processed.

There are also known methods of processing a printed roll of paper that do not use paper web folding and produce several books simultaneously. These are methods that reduce the generation of waste paper. As in the case of processing using signatures during processing, the printed roll of paper is unrolled and forms an endless paper web. Pieces, which are the pages of the books, are printed on such a paper web, with the pages of several books to be produced simultaneously printed in the transverse direction of the paper web. Usually there are at least pages of two books, and most often there are pages of three or four books. In the longitudinal direction of the paper web, all the pages of the books produced are printed in sequence.

In one such method, the printed web is first cut into longitudinal strips, the number of which corresponds to the number of pieces printed on the width of the paper web and which, in width, correspond to the width of a single book. The longitudinal strips are then cut transverse into individual book sheets, which are then brought together to form book blocks. This process produces books that have a number of pages that is a multiple of two. This results in a maximum of one blank page per finished book. In addition, longitudinal cutting and cross-cutting are carried out with a high degree of accuracy, which eliminates the amount of waste generated when trimming books. The disadvantage of this process, however, is the relatively slow processing speed, as the individual sheets being processed are very unstable and difficult to control, especially for thin papers. In addition, for this process, systems must be stopped in the event of a format change.

In contrast, DE102012103808A1 discloses a second method of producing book blocks from a printed paper web and an apparatus appropriate for this method. This method uses a printed paper web on which the pieces, i.e. the individual pages of the books being produced, are printed transversely in rows. In the transverse direction of the paper web, a row of pieces is printed next to each other, with the row containing at least two usages. In this method, the paper web thus printed is cut transversely after each row of pieces into individual transverse strips. The transverse strips are then collected and stacked one on top of the other from the first to last pages of the book blocks. In the next stage, the collected transverse strips are again cut in their transverse direction into individual book blocks. After this stage, the loosely stacked sheets of paper that make up the book blocks are auxiliary glued together, bringing the individual pages together to form a more stable book block, better adapted to further processing than a book block containing only folded individual sheets. After the gluing operation, the individual book blocks are transported for further processing. In order to ensure the reliability of the process, the stacks of transverse strips can also be glued auxiliary to each other. Bonding is then optional and carried out on at least one edge of the strips, and preferably auxiliary bonding is carried out on both long sides of the transverse strips. This way provides a faster book block production process than the way in which longitudinal cutting is carried out first and, moreover, book blocks can be produced at high speed, even with changing book formats. Picking up transverse strips is easier than picking up single sheets because they are heavier and therefore more stable, and the ability to process at higher speeds is also well influenced by auxiliary bonding. A major inconvenience is that sections of book blocks that have been auxiliary glued together during further processing must be removed, particularly if the auxiliary gluing is carried out on both long sides of the transverse strips.

DE102012103808A1 also discloses an apparatus for producing book blocks from a printed paper web which contains rows of printed book pages, and in the longitudinal direction of the web printed in sequence all the pages of the books produced. The unit contains the following arranged one behind the other: an apparatus for cutting transversely paper web, a stacking apparatus for stacking the cut transverse strips of paper, a splitting apparatus for cutting transverse strips of paper into book blocks. The unit may also include a levelling station located behind the stacking apparatus for stacking cut transverse strips of paper. Also optionally, an auxiliary gluing apparatus can be arranged in front of the splitting apparatus for cross-cutting paper strips into book blocks.

The aim of the invention is to increase the efficiency of converting a printed paper web into book blocks, and in doing so to provide an alternative solution for the bonding of the sheets forming a book block.

### SUMMARY OF THE DISCLOSURE

The object of the invention is a method for converting a printed paper web into book blocks, in which a printed paper web is processed, whereby the paper web has printed in the transverse direction rows of pages of at least two books to be produced simultaneously, and in the longitudinal direction the paper web has printed in sequence all the pages of these books. In this method:
a. the paper web is cut into transverse strips containing rows of pages,
b. transverse strips are collected and aligned to form stacks which are interconnected book blocks,
C. the stacks forming the interconnected book blocks are then crosscut into individual book blocks,
   wherein during the processing of the transverse strips, these transverse strips are glued to each other. The essence of the invention is that glue is applied to the upper surfaces of the transverse strips near the axes of the future cutting of these transverse strips into individual book blocks on the side corresponding to the spine of the future book block, wherein the glue is applied immediately after cutting the paper web on the transverse strips and before collecting the transverse strips in stacks, whereby after applying the glue, the transverse strips are collected in stacks and, after forming the stacks have been, these stacks of transverse strips are pressed in the gluing axes.

It is advantageous if the upper surface of the transverse strip, being the transverse strip corresponding to the last pages of the interconnected book blocks, is left unglued.

It is a good when the stacks of transverse strips are crosscut into individual book blocks using either a blade cut or at least one saw.

Two cross-cutting operations are then carried out during the processing of the paper web. In the first transverse-cutting operation, the paper web is cut into transverse strips containing rows of pages. Then, in subsequent stages of the process, once a stack of transverse strips is obtained, this stack of transverse strips is also crosscut. This is the direction of dissection resulting from the progression of the process and relating to this stack of transverse strips. If the reference point were a paper web, it would be a longitudinal cut. This description adopts an orientation that takes into account the progression of the process, so that both the paper web is cut transversely, and the stack of transverse strips is cut transversely.

Preferably, one of the pages is printed on the paper web in the transverse direction in a page row in an orientation that is 180° reversed from the other pages in that page row, and furthermore an area to be cut out is planned on the paper web and during further processing this area is cut out and the nominal width of the book produced is obtained, whereby preferably the stacks forming the interconnected book blocks are crosscut into individual book blocks and the area to be cut out is cut out using a single guillotine paper cutter and the cuts are made one after the other.

It makes sense that the transverse strips are collected in stacks using a star collecting wheel containing on its perimeter a plurality of evenly spaced blades, adapted to receive successive transverse strips and deposit them in a stack.

It is then a good idea if the transverse strips are directed alternately to two star collecting wheels separated from each other, with each star collecting wheel depositing the transverse strips in a stack, and after the transverse strips have been collected in the stacks, they are directed to the cross cutting system into individual book blocks.

The object of the invention is also an apparatus for converting a printed paper web into book blocks, comprising successively arranged systems: a transverse cutting system for cutting paper web into transverse strips, a system for collecting transverse strips into stacks and aligning them, a cross cutting system for cutting stacks of transverse strips into individual book blocks, and also comprising a glueing system. The essence of this invention lies in the fact that the glueing system is located between the transverse cutting system for cutting the paper web into transverse strips and the system for collecting the transverse strips into stacks, and is configured to apply the glue to the upper surfaces of the transverse strips at the axes of the future cutting of these transverse strips into individual book blocks on the side corresponding to the spine of the future book block.

It is a good idea for the system for gluing to include glue nozzles, advantageously adapted to apply rows of gluing points.

Advantageously, the system for collecting the transversal strips and aligning them comprises at least one star collecting wheel having on its periphery a plurality of evenly spaced blades adapted to receive successive transverse strips and to deposit them in a stack, the system for collecting the transverse strips in a stack being provided with a collecting station comprising aligning elements.

It is suitable if the system for collecting comprises two star collecting wheels positioned directly behind the gluing system and preferably arranged one above the other, and behind each star collecting wheel there is a collecting station assigned to that star collecting wheel.

Equally preferably, in front of the cross cutting system for cutting the stacks of transverse strips into individual book blocks, there is a station for aligning and positioning the stacks of transverse strips comprising a roller conveyor, a fixed buffer and an ejectable buffer, as well as a movable pusher and a movable gripper slidably mounted in the space between the rollers of the roller conveyor and adapted to push the stacks of transverse strips into the fixed buffer and the ejectable buffer, wherein the movable gripper is further configured to transport the stacks of transverse strips to a cross cutting system for cutting the stacks of transverse strips into individual book blocks, and the cross-cutting system comprises a guillotine paper cutter with a cutting stick and a blade and with a pressure bar configured to press the stack of transverse strips being cut against the cutting stick, and a book block receiving unit is arranged behind the cross cutting system.

It is reasonable if the book block receiving unit comprises a conveyor and directly behind the cross cutting system comprises a movable trapdoor movable between a first closed position, in which the trapdoor is part of the conveyor of the book block receiving unit, and a second open position, in which it is displaced relative to the plane of the conveyor of the book block receiving unit and opens a space allowing waste to be discharged from the cross cutting system.

Alternatively, instead of a guillotine paper cutter, the cross cutting system includes longitudinal guides and at least one saw assembly, wherein the single saw assembly includes a driven slider slidably mounted along the longitudinal guide and adapted for reciprocating movement along said longitudinal guide and having attached in sequence a pair of loading grippers, a circular saw, a pair of unloading grippers, wherein the cross cutting system comprises support tables fixed to the longitudinal guide and supporting the stack of transverse strips during the cutting operation, and comprises movable pressure beams adapted to press the stack of transverse strips against the support tables during the cross cutting operation, and a pair of loading grippers and a pair of unloading grippers are also slidably fixed in a direction perpendicular to the plane of the tables.

It is advisable that the longitudinal guides are slidably mounted on transverse guides oriented transversely to the direction of process movement of the stack of transverse strips and are provided with a drive which implements the reciprocating movement of the longitudinal guides along the transverse guides.

Advantageously, the support tables have a slot for the circular saw, wherein the support tables have a fixed position along the length of the longitudinal guides.

The main advantage of the invention resulting from the application of glue to the upper surfaces of the transverse strips, immediately after the paper web has been cut into transverse strips, is that book blocks pre-glued in the spine area and consisting of sheets of paper are obtained, which allows each book block to be transported during subsequent stages of bookbinding work without risk of damage. The processing of such book blocks can be done at high speed, unlike book blocks made up of loose sheets. The use of the described method of gluing does not make it necessary to remove fragments of glued sheets later but allows them to remain almost throughout whole time of the production process. The glue is applied in the area corresponding to the spine of the book and therefore requires gluing at the stage of joining the book blocks to the cover. By realising the method and using the machine, the amount of work and waste paper generated when changing the format of the book and/or changing the number of pages in the web width is also reduced. Changing these configurations does not require stopping the process and equipment, only appropriate changes to the equipment settings, including changing the position of the glue nozzles applying glue to the top surface of the transverse strips and changing the position of the equipment at the stage of cross cutting the stacks of transverse strips into individual book blocks. The use of a method and apparatus for converting the paper web into book blocks reduces the size of the machine and, in particular, its length, as the use of ploughs is not required.

By using glue nozzles, the correct amount of glue can be precisely dispensed onto the top surface of the transverse sheets. In addition, the glue application process can be controlled and regulated, for example by choosing between strip or dot application.

In addition, it is possible to produce several stacked book blocks by omitting to apply glue to the last sheet in the stack. With such gluing, the individual book blocks that make up the stack are not connected to each other, which simplifies further processing. In addition, obtaining stacks of book blocks at the collection stage, rather than individual blocks requiring gluing as in known solutions, makes it possible to cut higher stacks in subsequent stages and increases the efficiency of the process many times over.

On the other hand, the use of star collecting wheels prevents decomposition of the glue lying on the transverse strips. In particular, decomposition and smearing of the glue applied in the form of lines of glue dots through the sliding contact of the overlying transverse strip with the transverse strip already lying on the stack during stacking is eliminated. Taking the transverse strip into the blades of the star collecting wheel, moving it and rotating it by 180 degrees ensures that the transverse strips do not slide one after the other but only come into contact with each other when they are positioned one above the other.

The use of two star collecting wheels with collecting stations further increases production efficiency. The paper web is cut transverse at high speed compared to the process of collecting transverse strips in stacks. The use of two star collecting wheels allows the paper web to be continuously processed at high speed and transverse strips to be collected in stacks without slowing down the preceding process steps. In this configuration, the stacking of the transverse strips is alternated on two star collecting wheels. While one star collecting wheel with a collecting station collects the transverse strips and stacks them, time is gained in the second star collecting wheel and collecting station to empty this collecting station of the collected stack of transverse strips and redirect such a stack of transverse strips to the next process steps without loss of productivity. The collection station is therefore emptied without stopping or slowing down the paper web as the subsequent transverse strips flow into the second star collecting wheel with the collection station.

Cross-cutting of strip stacks can be carried out using two alternative methods and the equipment implementing them. State-of-the-art equipment, particularly guillotine paper cutter or circular saws, can be used to realise these cutting methods. What's more, cross cutting the stacks into book blocks using a guillotine paper cutter produces a smooth cut edge of the book block that can be treated as the final finish. Cross cutting transverse strips in this way produces individual book blocks containing a clean cut and a final finished book block edge lying opposite the spine for each book block.

By using cross cutting with a guillotine paper cutter, in particular with cuts which are done in sequence one after the other, and by using paper web containing one of the pages in an orientation 180° turned than the other pages in that page row, the efficiency of the book manufacturing process is significantly improved, in particular when manufacturing books from a paper web containing rows of pages printed in a transverse direction, for example page rows of three, four, five books. Clean cuts are then made to produce three individual book blocks having the final finished book edge located opposite the spine. This is of fundamental importance in the production of books with cover flaps, as the cut and final finished edge of the book opposite the spine is then obtained, thus avoiding the technologically difficult operation of cutting this edge after glueing into the cover, which requires the cover to be opened before cutting in order to avoid cutting the cover flaps. The final finished edge of the book opposite the spine, which remains in the finished product, eliminates the need to trim the book block on a three-knife trimmer, on any side other than the spine of the book, which occurs in methods using ploughs or circular saws. It is also not necessary to carry out the cutting out of the auxiliary gluing of book blocks, as in other methods known in the state of the art. Cutting on a guillotine paper cutter and using an inverted orientation of one of the pages also ensures that there is much less transmission of paper distortion caused by cutting forces to the spine of the book. This prevents distortion and the potential risk of spines tearing, as most cuts in a position where the previously glued spine of the resulting book is on the opposite side to the blade. The cut is made at the edge of the book opposite the spine of the book. In such case, the blade's attack surface is always on the unglued side of the book block, which allows the book block pages to slide away safely with the blade plunging into the stack.

At the same time, when cross cutting strips containing one of the sides in an orientation 180° reversed from the other sides in that row of sides, the area to be cut is cut out using a guillotine paper cutter. It is then important to remove waste from the cutting system, allowing only individual book blocks to be further processed. When cutting, particularly when carried out in sequence one after the other, the area to be cut must be cut out after two individual book blocks have been cut from the stack of transverse strips. Once this area has been cut out, it is immediately discharged from the cutting system and from the book block collection unit conveyor and goes, for example, into the waste paper bin.

Other advantages are associated with cross cutting carried out using circular saws, in particular with the implementation of a cross cutting operation using a saw assembly having a pair of loading grippers, a circular saw, a pair of unloading grippers mounted on a single slide. The saw assembly is then realised as a single kinematic chain, resulting in significant efficiency and cost savings by allowing the slider and connected components to be driven by a single motor. During one complete movement cycle of this saw assembly, several operations are carried out simultaneously:
positioning of the stack of transverse strips prior to loading into the cutting unit, in particular through the use of a pair of loading grippers having an integrated retaining element which fixes the position of the stack of transverse strips;
gripping the stack of transverse strips with loading grippers and loading them into position for cutting;
simultaneously with the loading of a stack of transverse strips, unloading the individual book blocks from the previously cut stack of transverse strips and pushing them out of the cutting system onto the output conveyor;
cutting with a circular saw of a stack of transverse strips in the cutting position with simultaneous movement of a pair of loading grippers to the loading position of another stack of transverse strips and a pair of unloading grippers to the unloading position of individual book blocks from the transverse strips stack being cut.

Furthermore, the design of the cutting unit with longitudinal guides moving along the transverse guides ensures that the saw assembly can be adjusted in between cross cutting the successive stacks of book blocks flowing into the cutting unit. Adjustment of the saw assembly is required when changing the number of pieces in the web width, requiring the introduction of another saw unit, or when changing the format of the book blocks or changing the web width—adjustment of the saw assembly by changing its position in relation to the paper web axis, thus changing its position in the transverse direction, is required. Adjusting the position of the saw assembly accordingly and adapting it, for example to a changed book format, does not require stopping the process and can be done automatically rather than manually. This solution enables non-stop production without the loss of productivity and waste paper associated with the need for an instrument during downtime, a drawback of many state-of-the-art solutions.

### BRIEF DESCRIPTION OF THE SEVERAL VIEWS OF THE DRAWINGS

The invention is illustrated in embodiments and a drawing, which shows at:

FIG. 1—first scheme for applying glue to the transverse strips with cut lines,

FIG. 2—second scheme for applying glue to transverse strips in perspective view of a stack of transverse strips with cut lines,

FIG. 3—apparatus for converting a printed paper web into book blocks in schematic perspective view in the first embodiment with a guillotine paper cutter,

FIG. 4.1-FIG. 4.6—successive views of the stacks of transverse strips in the cutting system glued together according to the second glue application scheme, including the stacks of transverse strips in the cutting system (FIG. 4.1), cutting the book blocks from the transverse strips (FIG. 4.2), gripping the book blocks (FIG. 4.3), opening the trap door (FIG. 4.4), closing the trap door (FIG. 4.5) and resetting the cutting system (FIG. 4.6),

FIG. 5—apparatus for converting a printed paper web into book blocks in schematic perspective view in the second embodiment with circular saws,

FIG. 6—apparatus for converting a printed paper web into book blocks in schematic perspective view in the second embodiment in with circular saws and with a collection system incorporating a star collecting wheel.

FIG. 7.1-FIG. 7.4—successive views of the transverse strip stacks in the cross cutting system with circular saws in the position of loading the transverse strip stacks into the cutting unit (FIG. 7.1), moving the transverse strip stacks to the cutting position (FIG. 7.2) pressing the pressure beams against the stacks in the cutting position and lowering all the grippers below the table surface (FIG. 7.3), the cutting of stacks of transverse strips (FIG. 7.4).

### DETAILED DESCRIPTION

In all of the examples described, a method of converting the printed paper web 1 into book blocks 2 was realised, in which the printed paper web 1 was processed. Paper web 1 has the page rows of at least two books to be produced simultaneously printed on both sides in the transverse direction, and in the longitudinal direction has all the pages of these books printed consecutively. In the embodiments, the pages of three books that have been produced simultaneously were printed on the paper web 1 in a transverse direction, in rows. In the longitudinal direction of the paper web 1 consecutive pages of these books were printed.

In the first step of converting the printed paper web 1 into book blocks 2, the printed paper web 1 was unrolled from the roll and cut with known equipment into transverse strips 3 containing rows of pages. Directly after cutting the paper web 1 into transverse strips 3, glue was applied to the upper surfaces of these transverse strips 3, near the axes of the future cutting of these transverse strips into individual book blocks 2 and on the side corresponding to the spine of the future book block 2. The glue was applied using glue nozzles and was applied in the form of rows of gluing points 4. In addition, the upper surface of the transverse strip 3, which is the transverse strip corresponding to the last pages of the interconnected book blocks, was left unglued.

The glue was applied using glue nozzles 5, allowing the correct amount of glue to be dispensed onto the top surface of the transverse sheets creating rows of glue dots 4. Rows of glue dots 4 were sprayed by glue nozzles 5 from above onto transverse strips 3, displaced underneath the glue nozzles 5, moving in the direction of movement P of the paper web 1.

The transverse strips 3 were then collected and aligned to form stacks 6 of transverse strips 3 being three interconnected book blocks 2. Due to the fact that the last pages of the interconnected book blocks were left unglued, groups containing several unconnected stacks of 6 transverse strips 3 corresponding to several stacks 6 of interconnected book blocks 2 were collected and formed. Once the stacks 6 of transverse strips 3 were formed, the stacks of transverse strips were pressed in the axes of the completed gluing to ensure good bonding.

Stacks 6 of transverse strips 3 were collected and aligned using state-of-the-art methods and equipment. Further transverse strips 3 containing rows of glue dots 4 on the upper surfaces coming in were collected in a collection arrangement surrounded by buffers to allow the stacks being collected to be aligned. Bands can be movable and can be vibrated to facilitate the alignment of the stacks 6 of transverse strips 3.

The stacks of transverse strips thus collected were then cut into individual book blocks using either a blade cut or at least one saw.

In realising the method of converting the printed paper web into book blocks, two glue application schemes were implemented. In both of these, the glue was applied in the form of rows of glue dots 4.

In the first scheme (FIG. 1) of the glue application, on web paper 1 the pages of the three books were printed on paper web 1 and had the same orientation. Three rows of glue dots 4 were applied at the edges corresponding to the future book spines. The stacked transverse strips 3 were to form three book blocks, so two cutting lines I, II were planned.

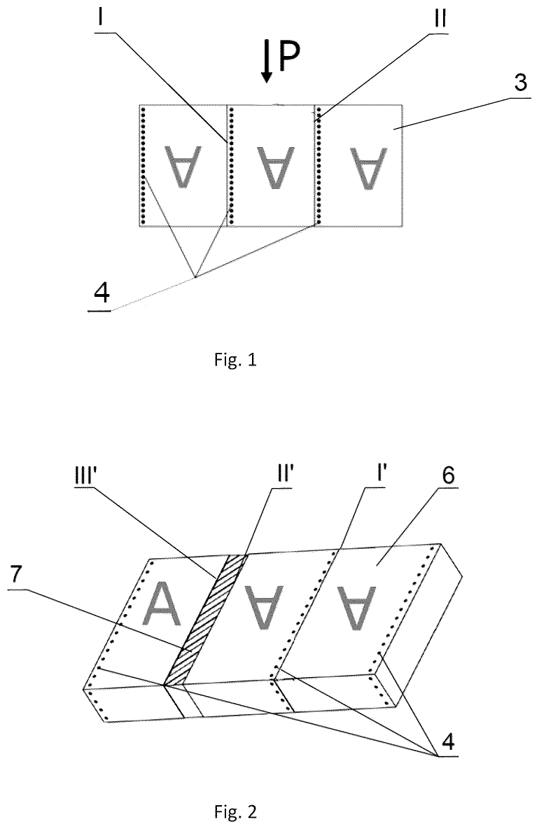

In the second scheme (FIG. 2) of the glue application, on paper web 1 in a row of page printed in the transverse direction one of the pages was printed in an orientation 180° turned from the other pages in that page row. One of the three printed pages in a row therefore had an orientation that was 180° turned than the other two pages. In addition, a cut-out area 7 was planned on the paper web 1, which was cut out during further processing to obtain the nominal width of the book produced. As in the previous scheme, three rows of glue dots 4 were applied at the edges corresponding to the future book spines. Three cutting lines I′, II′, III′ were planned to obtain the three book blocks 2 and the area to be cut out. In subsequent operations, in order to obtain the final cut of the edge lying opposite the spine of the book, it is good if the cut is made with a guillotine paper cutter and the cuts are made one after the other.

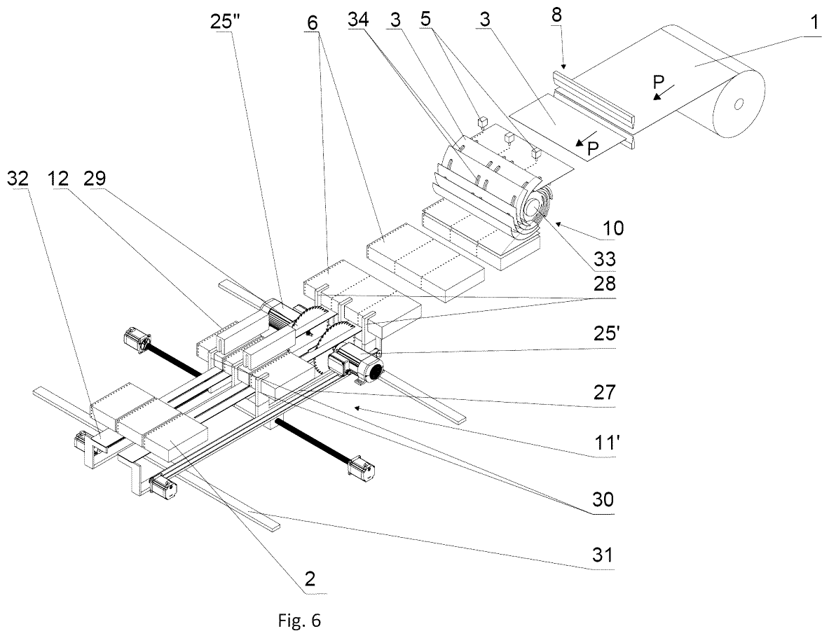

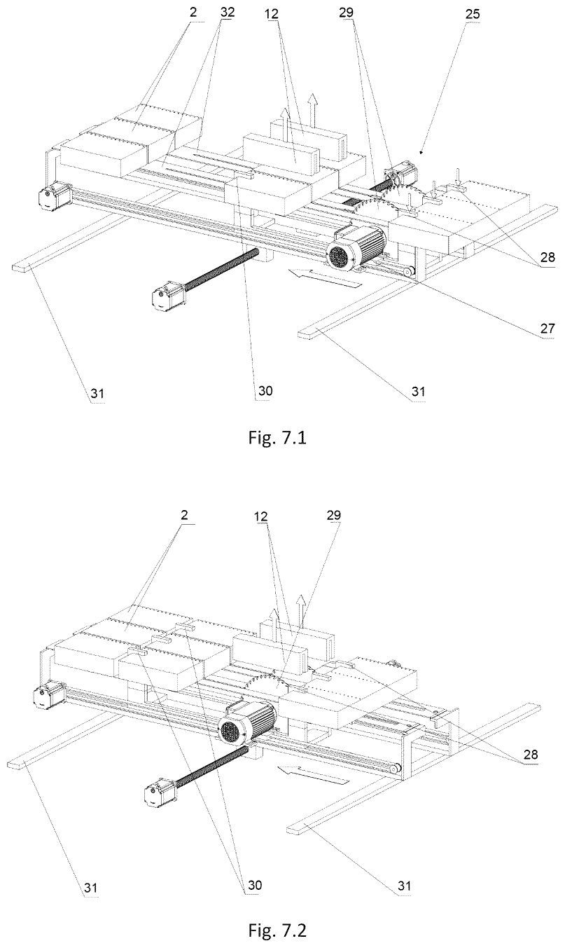

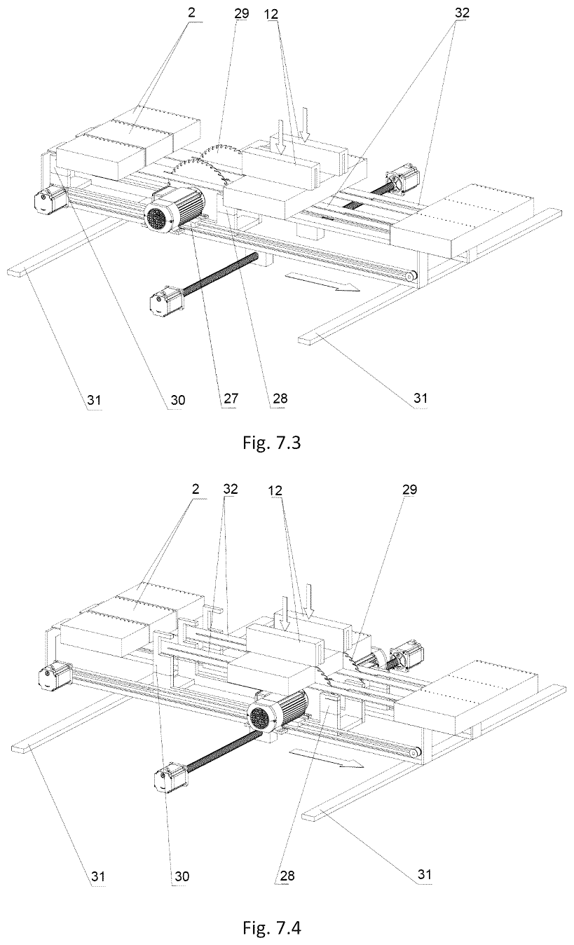

In other embodiments for the collection of transverse strips 3 (FIG. 6) a star collecting wheel 33 comprising on its perimeter a number of evenly spaced blades 34 adapted to receive successive transverse strips and deposit them in a stack 6 may be used. Then successive oncoming transverse strips 3 with rows of glue points 4 are first picked up by the blades 34 of the star collecting wheel 33, and then by the rotational movement of this star collecting wheel 33 are deposited in the stack 6. Taking the transverse strip 3 into the blades 34 of the star collecting wheel 33, transferring and rotating it 180 degrees ensures that the transverse strips 3 only come into contact with each other when they are positioned one above the other.

Irrespective of the glue application scheme implemented and the way in which the transverse strips 3 are collected in stacks 6 when converting the printed paper web 1 into book blocks 2, a converting apparatus can be used using either a guillotine paper cutter or a circular saw.

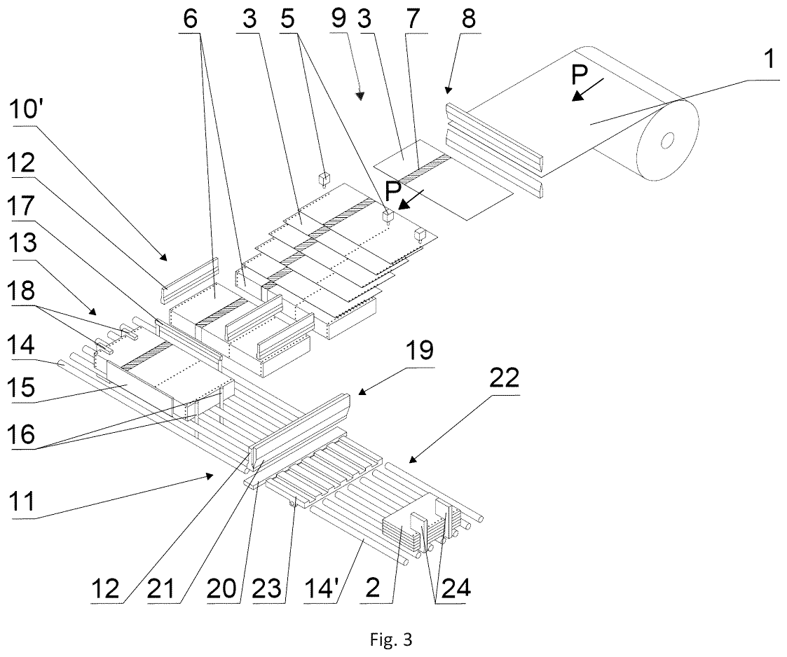

The following embodiment shows a cut using a guillotine paper cutter implemented for the second scheme (FIG. 2) of the glue application. The apparatus for converting (FIG. 3) the printed paper web 1 into book blocks 2 comprises the following successively arranged systems: the system for unrolling the paper web 1 from the roll, the transverse cutting system 8 of the paper web 1 into transverse strips 3, system for gluing arrangement 9 followed by the system of collecting 10 transverse strips 3 into stacks 6 and cross-cutting system 11 for stacks 6 of transverse strips 3 into individual book blocks 2.

Following the transverse cutting system 8 is a system for gluing 9, which is configured to apply glue to the upper surfaces of the transverse strips 3 at the axes of the future cutting of these transverse strips 3 into individual book blocks 2 on the side corresponding to the spine of the future book block 2. The system for gluing 9 contains glue nozzles 5 adapted to apply rows of glue dots 4.

The system for collecting 10 includes a station for collecting transverse strips 3 in stacks 6 bounded by buffers to allow the collected stacks to be aligned. Buffers can be movable and can be vibrated to facilitate the alignment of the stacks 6 of transverse strips 3 joined with. The system for collecting 10 have also attached movable pressure beams 12 for pressing the stacks 6 of transverse strips 3 in the axes of the realised gluing, and therefore at the points where the rows of gluing points 4 are superimposed.

The system for cross-cutting 11 the stacks 6 of transverse strips 3 into individual book blocks 2 comprises an aligning and positioning station 13 for the stacks 6 of transverse strips 3 having a roller conveyor 14, a fixed buffer 15 and an ejectable buffer 16, as well as a movable pusher 17 and a movable gripper 18 mounted in a sliding manner in the space between the rollers of the roller conveyor 14 and adapted to push the stacks 6 of transverse strips 3 against the fixed buffer 15 and the ejectable buffer 16. The movable gripper 18 is configured to transport the stacks 6 of transverse strips 3 to the cross-cutting apparatus for cutting the stacks 6 of transverse strips 3 into individual book blocks 3. The cross-cutting apparatus 19 comprises a guillotine paper cutter with a cutting stick 20 and a blade 21, and with a movable pressure bar 12 configured to press the cut stack 6 of transverse strips 3 against the cutting stick 20. Behind the cross-cutting apparatus 19 is the receiving unit 22 for book blocks 2.

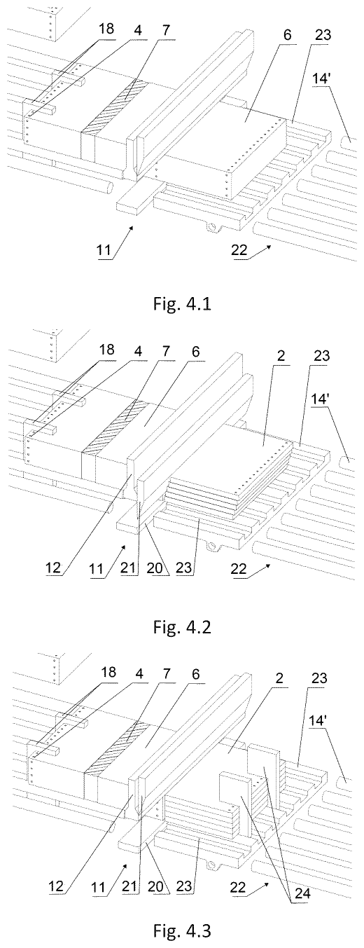

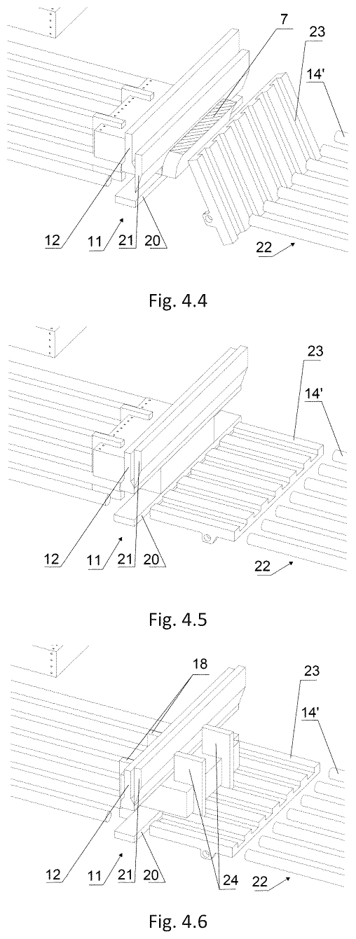

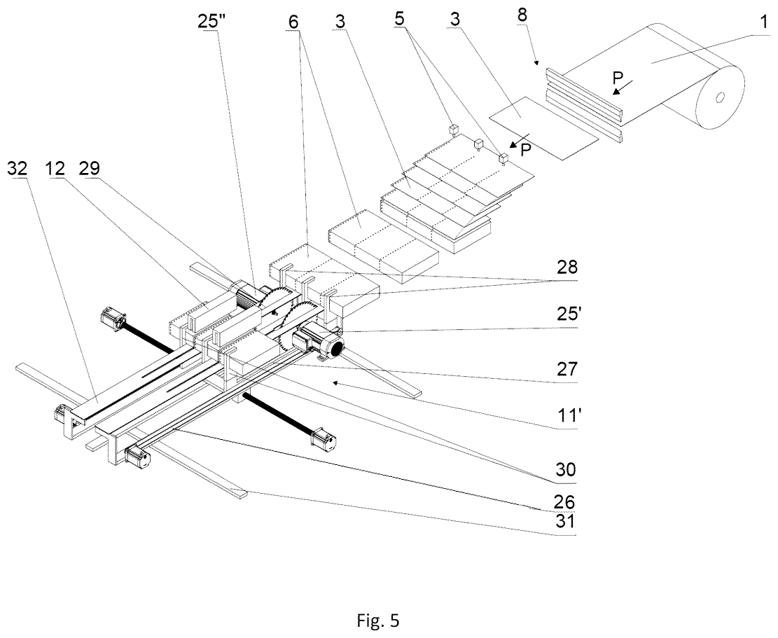

Receiving unit 22 (FIG. 4) of book blocks 2 includes a roller conveyor 14′ and a movable trapdoor 23 located directly behind the cross-cutting system 11 for stacks 6 of transverse strips 3 into individual book blocks 2. The movable trapdoor 23 is articulated on a bracket and is moved by an actuator between the first closed position (FIG. 4.1), in which the trapdoor is a section of the roller conveyor 14′ of the receiving unit 22 of the book blocks 2, and the second open position (FIG. 4.4) in which it is displaced relative to the plane of the roller conveyor 14′, in this example it is raised by an actuator to a tilted position, thereby opening up the space beneath the roller conveyor 14′. In the embodiment, this is the space that allows waste to be discharged from the cross-cutting system 11 of the transverse stacks 6 of transverse strips 3 into individual book blocks 2 and in which the waste paper tray is located. A movable and adaptable gripper 24 of the receiving unit is fixed in the receiving unit 22 between the rollers of the roller conveyor 14′ and adapted to realise reciprocating movement. It allows the book blocks coming out of the cross-cutting unit 19 to be captured and further transported along the 14′ roller conveyor.

Using the apparatus for converting the printed paper web 1 into book blocks 2, the following operations were performed:
unrolling the paper web 1,
cutting of this paper web 1 transversely using a transverse cutting system 8 into transverse strips 3,
transporting the transverse strips 3 under the glue nozzles 5 with the application of rows of glue dots 4 while collecting and aligning the transverse strips 3 in stacks 6 using a system for pressing 10′, and then pressing the stacks 6 of transverse strips 3 in the axes where the rows of glue dots 4 have been applied,
transporting the stacks 6 of transverse strips 3 to the system for cross-cutting 11 the stacks 6 of transverse strips 3 into individual book blocks 2, where the positioning of the stacks 6 took place prior to the cutting operation at the alignment and positioning station 13. The stack 6 of transverse strips 3 which was coming in on the roller conveyor 14 was held by a fixed buffer 15 positioned along the future direction of movement of the stack 6 of transverse strips 3 and an ejectable buffer 16 positioned across the future direction of movement of the stack 6 of transverse strips 3. The movable pusher 17 then pushed the stack 6 of transverse strips 3 to the fixed bumper 15, and the movable gripper 18 pushed the stack 6 of transverse strips 3 to the ejectable bumper 16. Once the stack 6 was stabilised in this way in two axes, the movable gripper 18 squeezed and gripped the stack while the movable pusher 17 moved away from the stack 6 transverse strips and the ejectable bumper 16 retracted under the plane of the roller conveyor 14. The movable gripper 18 then moved the held stack 6 of transverse strips towards the cross-cutting apparatus 19, until the position where the first cutting line I′ was in the area of the blade 21.
cutting with the cross-cutting apparatus 19, where cutting in cutting lines I′ and II′ followed the same sequence of events, in which the stack 6 of transverse strips 3 was pressed by the movable pressure bar 12 against the cutting stick 20 and then cut with the blade 21. The cut-off book block 2 is transported in the receiving unit 22 with the movable trapdoor 23 set in the first closed position.
cutting with the cross-cutting apparatus 19, carried out for the cutting line III′, wherein first the trapdoor 23 was set to the second open position and then the stack 6 of transverse strips 3 was moved to a position where the cutting line III′ was in the area of the blade 21, followed by the cutting process in which the stack 6 of transverse strips 3 was pressed by the movable pressure bar 12 against the cutting stick 20 and then cut by the blade 21. The area to be cut out 7 was then cut off, which as waste paper fell by gravity into the space created when the trapdoor 23 was raised to the second open position. Subsequently, the alignment of the trapdoor 23 to the first closed position was realised, and the remaining section of the stack 6 of transverse strips 3 forming the book blocks 2 at this stage was transported in the receiving unit 22.

The cutting in cut lines II′ and III′ was carried out on the opposite side to the spine of the book. This reduced the transmission of paper deformation caused by cutting forces to the spine. This prevented deformation and potential tearing of book spines.

The individual book blocks 2 coming after cutting the stack of transverse strips 3 are transported in the receiving unit using the gripper 24 of the receiving unit and then the roller conveyor 14′ until they are led out of the machine.

The following embodiment shows a cut using circular saws implemented for the first scheme (FIG. 1) of the glue application. The apparatus for converting (FIG. 5) printed paper web 1 into book blocks 2 comprises the consecutively arranged systems: a system for unrolling the paper web 1 from the roll, a transverse cutting system 8 for cutting the paper web 1 into the transverse strips 3, a system for gluing 9, and then a system for collecting the transverse strips 3 into stacks 6, which are realised as in the previous example.

The difference relates to cross-cutting system 11′ for cutting stacks 6 of transverse strips 3 into single book blocks 2, comprising at least one saw assembly 25. The cross-cutting system 11′ comprises two longitudinal guides 26 and two saw assemblies 25 connected to them—a first saw assembly 25′ and a second saw assembly 25′. In addition, the cross-cutting system 11′ includes support tables 32 supporting stacks 6 of transverse strips 3 during cutting operation. The first saw assembly 25′ is the basic assembly and is designed for the basic cutting of stack 6 of transverse strips 3 into a minimum number of book blocks 2, that is, into two book blocks 2. The first saw assembly 25′ comprises a driven slider 27 slidably mounted along the longitudinal guide 26 and adapted for reciprocating movement along this longitudinal guide 26. A pair of loading grippers 28, a circular saw 29 and a pair of unloading grippers 30 are attached to the slider 27 in sequence. In each pair of loading grippers 28 and unloading grippers 30, individual grippers are arranged on either side of the circular saw 29. Pairs of loading grippers 28 and unloading grippers 30 are also slidably mounted in a direction perpendicular to the plane of the supporting tables 32, so that they can be lowered below the stack 6 of the transverse strips 3 being cut. Pairs of loading grippers 28 and unloading grippers 30 are used to grasp first the stack 6 of transverse strips 3 in the part corresponding to each book block 2, and after the cutting operation they are used to grasp each individual book block 2. The second saw assembly 25″ has a design analogous to the first saw assembly but is an additional assembly designed to cut a stack 6 of transverse strips 3 into successive book blocks, as in the example, into three book blocks 2. Therefore, it has one loading gripper 28, a circular saw 29 and one unloading gripper 30. The loading gripper 28 and the unloading gripper 30 are located on one side of the saw and serve at the beginning to grasp the stack 6 of transverse strips 3 in the part corresponding to the next book block 2 and, after the cutting operation, to grasp this cut book block 2. The individual loading grippers 28 and the unloading grippers 30 are also slidably mounted in a direction perpendicular to the longitudinal guide 26, so that during cutting they can be lowered below the cut stack 6 of the transverse strips 3.

The longitudinal guides 26 are driven and are slidably mounted on the transverse guides 31 oriented transversely to the direction of process movement P of the stack 6 of transverse strips 3. The drive, in the form of a helical gearbox, carries out the reciprocating movement of the longitudinal guides 26 along the transverse guides 31.

The movement of each saw assembly 25 along the longitudinal guides 26 is a process movement, and the following operations are carried out during one complete movement cycle of this saw assembly 25:
positioning of the stack 6 of transverse strips 3 prior to loading into the system for cross-cutting 11′ by using a pair of loading grippers 28 having an integrated retaining element which fixes the position of the stack 6 of transverse strips 3. The single loading gripper 28 has a vertical bracket acting as a retaining element and two jaws, upper and lower, which, moving along the vertical bracket, can clamp on the stack 6 of transverse strips 3;
gripping a stack 6 of transverse strips with 3 loading grippers 28 and loading into position for cutting;
simultaneous with the loading of a stack 6 of transverse strips 3 the unloading of individual book blocks 2 formed from a previously cut stack 6 of transverse strips 3 in an earlier movement cycle;
pushing outside the cross-cutting system 11 onto the exit conveyor the book blocks 2 previously unloaded from the cross cutting system 11′;
cutting with a circular saw 29 of a stack 6 of transverse strips 3 being in the cutting position with simultaneous movement of a pair of loading grippers 28 to the loading position of another stack 6 of transverse strips 3, and of a pair of unloading grippers 30 to the unloading position of individual book blocks 2 from the cut stack 6 of transverse strips 3.

The movement of each saw unit 25 along the longitudinal guides 26 is carried out by means of a single drive unit equipped with a stepper motor and strip transmission where the slider is fixed to a fixed point on the strip. Other gears, such as chain, helical or rack-and-pinion gears, can also be used for this purpose.

On the other hand, the movement of the longitudinal guides 26 together with the slider 27 along the transverse guides 31 is the movement that allows the saw assembly 25 to be set. Adjustment of the saw assembly 25 is required when changing the number of pieces, printed pages, on the width of the paper web, requiring the introduction of another saw assembly 25, or when changing the format of book blocks 2 or changing the width of the paper web—an adjustment of the saw assembly 25 is required by changing its position in relation to the axis of the paper web, thus changing its position in the transverse direction. The saw setting must correspond to the planned cutting lines.

The cross-cutting system 11′, in addition to the support tables 32 supporting the stacks 6 of transverse strips 3 during the cutting operation, comprises movable pressure beams 12 adapted to press the stack 6 of transverse strips 3 against the support tables 32 during the transverse cutting operation. The support tables 32 are fixed to the longitudinal guides 26 and have a slot for the circular saw blade 29. The support tables 32 associated with the longitudinal guides 26 can be relatively narrow and perform a lateral movement together with the longitudinal guide 26. The space between the tables 26 can be made to provide support for the stacks 6 of transverse strips 3 and then for the stacks of book blocks 2, especially for the production of book blocks 2 with substantial formats. In this case, in the space between the tables, there may be a support structure made of thin steel flat bars connected by the honeycomb principle or parallel bars suspended on horizontal bars, with springs in the spaces between the flat bars.

During the process movement of the saw assembly 25, the loading grippers 28 and the unloading grippers 30 assume the following positions:
the raised open position of the loading gripper 28 and the unloading gripper 30, in which the loading gripper 28 and the unloading gripper 30 are raised above the table 32, their lower jaws are in a position just below the surface of the table 32: from −1 to −3 mm, and the upper jaws are open to the maximum. In this position, positioning is carried out and leaving the stack 6 of transverse strips 3 loaded into the cutting position, and pushing out the individual book blocks 2 produced from the cut stack 6 of transverse strips 3,
the closed raised position of the loading gripper 28 and the unloading gripper 30, in which the loading gripper 28 and the unloading gripper 30 are raised above the table 32, their lower jaws are in a position slightly above the surface of the table 32 between +0.5 and +3 mm, and the upper jaws squeeze the stack 6 of transverse strips 3. In this position, the loading of the stack 6 of transverse strips 3 and the unloading of the individual book blocks 2 produced from the cut stack 6 of transverse strips 3 is performed,
the lowered closed position of the loading gripper 28 and the unloading gripper 30, in which the loading gripper 28 and the unloading gripper 30 are lowered below the table 32. In this position, a cut is made with the circular saw 29, during which the loading gripper 28 and the unloading gripper 30 located under the table 32 pass the material which is being cut on the table—a stack 6 of transverse strips 3.

When changing the pieces on the width of the paper web, 1 cutting unit can contain any suitable number of saw assemblies 25. In particular, it can be:
one saw assembly 25 for the transverse strips 3 cut into two book blocks, thus for the paper web 1 having two pieces printed in a row,
two saw assemblies 25 for the transverse strips 3 cut into three book blocks, thus for the paper web 1 having three pieces printed in a row,
three saw assemblies 25 for the transverse strips 3 cut into four book blocks, thus for the paper web 1 having four pieces printed in a row, etc.

Changes to the setting of the cross-cutting system 11 with the saw assemblies 25 can be carried out automatically, without stopping other systems, it being sufficient to move the saw assemblies 25 to do so. For example, when changing the number of pieces on the paper web from three to two, the cutting operation was carried out with two saw assemblies 25 and stacks 6 of transverse strips 3 were cut into two book blocks 2. Bringing one saw assembly 25 to the side of the machine beyond the width of the stacks 6 of transverse strips 3 and positioning the primary saw assembly 25 in the centre of the stacks 6 of transverse strips 3 in the cutting line, allows for the cutting of the stacks 6 of transverse strips 3 into two book blocks 2.

The control of the individual systems and the apparatuses that make them up and their adjustment to the height of the book blocks 2 being produced, the length of the rows of gluing points 4, the presence or absence of gluing on transverse strips 3, the number of transverse strips 3 in a single stack 6, the number of saw cuts and their position on the width of transverse strips 3 is realised by optical sensors reading the control marks printed on the paper web on the margin to be cut off in the further stages of the bookbinding process.

Another example of implementation (FIG. 6) is analogous to that described above with the difference that the system for collecting 10 transverse strips 3 into stacks 6 comprises a star collecting wheel 33 equipped at its periphery with a number of evenly spaced blades 34 adapted to receive successive transverse strips 3 and deposit them into the stack 6. For this purpose, the blades 34 take the form of four rods supporting and carrying a single transverse strip 3.

In a further embodiment, not shown in the figure, a system for collecting transverse strips 3 in stacks 6 including two systems for collecting transverse strips 3 in stacks 6 is formed. They are arranged one above the other or alternatively one behind the other. Each of the collecting systems includes a star collecting wheel 33 for collecting the transverse strips 3 in stacks 6. In this example, two star collecting wheels 33 are arranged directly behind the gluing system 9 and arranged one above the other. The gluing system comprises a conveyor above which the glue nozzles are located and which alternately directs the coming transverse strips 3 to one of the two star collecting wheels. The systems for collecting are preceded by a separate switch that directs oncoming sheets to either one or the other system for collection. In order to maintain the high processing speed of the paper web 1 transverse strips 3 are collected in stacks 6 alternately by each of the star collecting wheels 33. At this stage, therefore, the processing of the paper web 1 is split into two separate production streams in which the collection of the transverse strips 3 into stacks 6 is carried out. Then, via a set of conveyors, the transverse strips 3 collected in stacks 6 on the two systems for collection are directed to a single system for cross-cutting 11, so the two production streams merge and further processing is carried out in a single production stream. By splitting the collection of transverse strips 3 into two collection systems, the whole process can be significantly improved by speeding up the operations carried out in the collection system.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for converting a printed paper web into book blocks, in which the printed paper web is processed, wherein the paper web has printed in a transverse direction rows of pages of at least two books to be produced simultaneously, and in a longitudinal direction the paper web has printed sequentially all pages of the two or more books and in which:
a. the paper web is cut into transverse strips containing rows of pages,
b. the transverse strips are collected and aligned to form stacks which are interconnected book blocks,
c. and the stacks forming the interconnected book blocks are cross cut into individual book blocks,
wherein during processing of the transverse strips, the method comprises gluing the transverse strips to each other, characterized in that a glue is applied to the one or more upper surfaces of the transverse strips near axes resulting from the axes cutting of the transversal strips into individual book blocks on a side corresponding to the a spine of the book block, wherein the glue is applied after cutting the paper web on the transverse strips and before collecting the transverse strips in stacks, whereby after applying the glue, the transverse strips are collected in stacks and after forming the stacks, the stacks of transverse strips are pressed together.

2. The method for converting a printed paper web into book blocks according to claim 1, characterized in that the upper surface of the transverse strip, being the transverse strip corresponding to the last pages of the interconnected book blocks, is left unglued.

3. The method for converting a printed paper web into book blocks according to claim 1, characterized in that the stacks of the transverse strips are cross cut into individual book blocks using either a blade cut or at least one saw cut.

4. The method for converting a printed paper web into book blocks according to claim 1, characterized in that on the paper web in the transverse direction in a row of pages one of said pages is printed in an orientation inverted by 180° than another page in the row of pages, and furthermore on the paper web a cut-out area is planned and during further processing the cut-out area is cut out and the nominal width of the book being produced is obtained, whereby advantageously the stacks forming the interconnected book blocks are cross cut into individual book blocks and the cut-out area is cut out using a guillotine paper cutter with cuts are made one after the other.

5. The method for converting a printed paper web into book blocks according to claim 1, characterized in that the transverse strips are collected in stacks using a star collecting wheel comprising on a periphery a plurality of evenly spaced blades adapted to receive the successive transverse strips and to deposit the transverse strips in a stack.

6. The method for converting a printed paper web into book blocks according to claim 4, characterized in that the transverse strips are directed alternately to two separated star collecting wheels, each star collecting wheel depositing the transverse strips into a stack, and after the transverse strips have been collected into the stacks, the transverse strips are directed to the cross cutting apparatuses into individual book blocks.

7. An apparatus for converting a printed paper web into book blocks, comprising a plurality of successively arranged systems including a transverse cutting system for a paper web into transverse strips, a system for collecting the transverse strips into stacks and aligning them, a cross cutting system for cutting stacks of transverse strips into individual book blocks, and a gluing system, wherein the gluing system is located between the transverse cutting system of the paper web into transverse strips, and the system for collecting the transverse strips into stacks and is configured to apply a glue to one or more upper surfaces of the transverse strips near axes associated with cross cutting of transverse strips into individual book blocks on a side corresponding to a spine of the book blocks.

8. The apparatus for converting a printed paper web into book blocks according to claim 7, characterized in that the gluing system comprises glue nozzles, advantageously adapted to apply rows of gluing points.

9. The apparatus for converting a printed paper web into book blocks according to claim 7, characterized in that the system for collecting transverse strips in stacks and aligning them comprises at least one star collecting wheel having on a periphery a plurality of evenly spaced blades adapted to receive successive transverse strips and deposit the transverse strips in a stack, the system for collecting transverse strips in stacks being provided with a collecting station comprising aligning elements.

10. The apparatus for converting a printed paper web into book blocks according to claim 9, characterized in that the system for collecting comprises two star collecting wheels positioned directly behind the gluing system and preferably arranged one above the other, and behind each star collecting wheel there is a collecting station assigned to that the respective star collecting wheel.

11. The apparatus for converting a printed paper web into book blocks according to claim 7, characterized in that in front of the cross cutting system stacks of transverse strips into individual book blocks there is a station for aligning and positioning the stacks of transverse strips comprising a roller conveyor, a fixed buffer and an ejectable buffer, a movable pusher and a movable gripper slidably mounted in the space between the rollers of the roller conveyor and adapted to push the stacks of transverse strips against the fixed buffer and the ejectable buffer, whereby the movable gripper is further configured to transport the stacks of transverse strips to the cross-cutting apparatus for cutting the stacks of transverse strips into individual book blocks, and the cross-cutting apparatus comprises a guillotine paper cutter with a cutting stick and a blade, and with a movable pressure bar configured to press the stack of transverse strips being cut against the cutting stick, and the book block receiving unit is arranged behind the cross-cutting apparatus.

12. The apparatus for converting a printed paper web into book blocks according to claim 11, characterized in that the book block receiving unit comprises a conveyor, and directly behind the cross cutting system comprises a movable trapdoor movable between a first closed position, in which the trapdoor is part of the conveyor of the book block receiving unit, and a second open position, in which it is displaced relative to the plane of the conveyor of the book block receiving unit and opens a space allowing waste to be discharged from the cross cutting system.

13. The apparatus for converting a printed paper web into book blocks according to claim 7, characterized in that the cross cutting system comprises longitudinal guides and at least one saw assembly, wherein the single saw assembly includes a driven slider slidably mounted along the longitudinal guide and adapted for reciprocating movement along said longitudinal guide and having attached in sequence a pair of loading grippers, a circular saw, a pair of unloading grippers, wherein the cross-cutting system comprises support tables attached to the longitudinal guides and supporting stacks of transverse strips during the cutting operation, and comprises movable pressure beams adapted to press the stack of transverse strips against the support tables during the transverse cutting operation, wherein a pair of loading grippers and a pair of unloading grippers are also movably fixed in a direction perpendicular to the plane of the support tables.

14. Apparatus for converting a printed paper web into book blocks according to claim 13, characterized in that the longitudinal guides are slidably mounted on transverse guides oriented transversely to the direction of process movement (P) of the stack of transverse strips and are provided with a drive which implements the reciprocating movement of the longitudinal guides along the transverse guides.

15. The apparatus for converting a printed paper web into book blocks according to claim 13, characterized in that the support tables have a slot for a circular saw, wherein the support tables have a fixed position along the length of the longitudinal guides.
